(19) United States
(12) Patent Application Publication
(10) Pub. No.: US 2020/0182992 A1
(43) Pub. Date: Jun. 11, 2020

(54) ENHANCED OBJECT DETECTION AND MOTION STATE ESTIMATION FOR A VEHICLE ENVIRONMENT DETECTION SYSTEM

(71) Applicants: Dominik KELLNER, Dachau (DE); Nicolas SCHNEIDER, München (DE)

(72) Inventors: Dominik KELLNER, Dachau (DE); Nicolas SCHNEIDER, München (DE)

(73) Assignee: VEONEER SWEDEN AB, VARGARDA (SE)

(21) Appl. No.: 16/306,218

(22) PCT Filed: Jun. 1, 2017
(86) PCT No.: PCT/EP2017/063380

§ 371 Date: Nov. 30, 2018

(30) Foreign Application Priority Data
Jun. 3, 2016 (EP) 16172790.4

(51) Int. Cl. G01S 13/58; G01S 13/931; G01S 7/41; B60R 11/04; G01S 13/86

(52) U.S. Cl. CPC G01S 13/584; G01S 13/931; G01S 13/589; B60R 11/04; G01S 13/867; G01S 7/415

(57) ABSTRACT

The present disclosure relates to a vehicle environment detection system arranged to detect at least one detection and comprises at least one radar system, at least one camera device and at least one processing unit. For each radar detection at least one azimuth detection angle with respect to an x-axis and a detected Doppler velocity component that is constituted by detected Doppler velocity with respect to the radar system are obtained. For each detection, said processing unit is arranged to:
Obtain corresponding camera detections for at least two image frames, constituting an optical flow.
Determine a velocity y-component from said optical flow, where the velocity y-component is constituted by a projection of a resulting velocity onto a y-axis that extends perpendicular to the x-axis.
Determine the resulting velocity from the detected Doppler velocity component and the velocity y-component.

### CROSS-REFERENCE TO RELATED APPLICATIONS

This application is a 35 U.S.C. § 371 national phase of PCT International Application No. PCT/EP2017/063380, filed Jun. 1, 2017, which claims the benefit of priority under 35 U.S.C. § 119 to European Patent Application No. 16172790.4, filed Jun. 3, 2016, the contents of which are incorporated herein by reference in their entirety.

### SUMMARY OF THE DISCLOSURE

The present disclosure relates to a vehicle environment detection system arranged to detect at least one detection for objects outside a vehicle. The vehicle environment detection system comprises at least one radar system, at least one camera device and at least one processing unit. For each detection, said radar system is arranged to obtain at least one azimuth detection angle and a detected Doppler velocity component.

Today, a Doppler radar system may be mounted on a vehicle in order to detect reflections from objects in order to implement functions such as speed control and collision prevention, as well as others. In such a radar system, it is required to obtain an azimuth angle in the form of a target bearing angle, a distance with respect to the object and a relative velocity between the vehicle and the object.

Many such Doppler radar systems comprise means for generating so-called chirp signals that are transmitted, reflected and received by means of appropriate antennas comprised in the radar system. A chirp signal is an FMCW (Frequency Modulated Continuous Wave) signal with a certain amplitude where the frequency is continuously ramped between two values, the chirp signal thus being in the form of a continuous sinusoid where the frequency varies from a first low frequency to a second high frequency over the course of the ramp. The change in frequency from start to finish, the bandwidth, may for example be of the order of 0.5% of the starting frequency.

The received signals, thus constituted by reflected radar echoes, are mixed with the transmitted chirp signal in order to convert the received signals to baseband signals. These baseband signals, or IF (Intermediate Frequency) signals, are amplified and transferred in a plurality of channels to an Analog Digital Converter (ADC) arrangement which is arranged to convert the received analog signals to digital signals. The digital signals are used for retrieving an azimuth angle of possible targets by simultaneously sampling and analyzing phase and amplitude of the received signals. The analysis is generally performed in one or more Digital Signal Processors (DSP:s) by means of Fast Fourier Transform (FFT) processing.

The detected relative velocity is only obtained as a radial velocity component directed between the vehicle and the object, while other velocity components are not detected. Furthermore, a yaw rate that depends on if the object is turning is also of interest to determine.

There is thus a need for a device and a method for a vehicle Doppler radar system where a two-dimensional velocity vector of a point source such as a moving direction and velocity of a pedestrian, is determined. There is also a need for a device and a method for a vehicle Doppler radar system where a full motion state of an extended object having three degrees of freedom in a plane is determined, for example moving direction, velocity and turning/yaw rate. A velocity vector comprises both velocity and direction.

Said object is achieved by means of a vehicle environment detection system arranged to detect at least one detection for at least one corresponding object outside a vehicle. The vehicle environment detection system comprises at least one radar system, at least one camera device and at least one processing unit. For each radar detection, said radar system is arranged to obtain at least one azimuth detection angle with respect to an x-axis and a detected Doppler velocity component that is constituted by detected Doppler velocity with respect to the radar system. For each detection said processing unit is arranged to:
Obtain corresponding camera detections from said camera device for at least two image frames, constituting an optical flow.
Determine a velocity y-component from said optical flow, where the velocity y-component is constituted by a projection of a resulting velocity onto a y-axis that extends perpendicular to the x-axis and forms an aperture plane axis for said camera device.
Determine the resulting velocity from the detected Doppler velocity component and the velocity y-component.

Said object is also achieved by means of a method for determining a resulting velocity for at least one detection for objects outside a vehicle, where the method comprises:
Obtaining at least one radar detection azimuth detection angle with respect to an x-axis using a radar system.
Obtaining a corresponding detected Doppler velocity component that is constituted by detected Doppler velocity with respect to the radar system.

For each detection the method further comprises:
Obtaining corresponding camera detections from a camera device for at least two image frames, constituting an optical flow.
Determining a velocity y-component from said optical flow, where the velocity y-component is constituted by a projection of the resulting velocity onto a y-axis that extends perpendicular to the x-axis and forms an aperture plane axis for said camera device.
Determining the resulting velocity from the detected Doppler velocity component and the velocity y-component.

Said object is also achieved by means of a vehicle environment detection system arranged to detect at least one radar detection for objects outside a vehicle. The vehicle environment detection system comprises at least one radar system, at least one camera device and at least one processing unit. For each radar detection, said radar system is arranged to obtain at least one azimuth detection angle with respect to an x-axis and a detected Doppler velocity component that is constituted by detected Doppler velocity with respect to the radar system. Said processing unit (5) is arranged to obtain at least one camera detection from said camera device, where a sum of the number of radar detections and the number of camera detections is at least three. The vehicle environment detection system is arranged to calculate a two-dimensional motion state of the target object by solving the linear equation system

$$[ \begin{matrix}{v}_{D 1} \\ ⋮ \\ {v}_{DN} \\ {v}_{y 1}^{′} \\ ⋮ \\ {v}_{yM}^{′}\end{matrix} ] = [ \begin{matrix}{x}_{S} sin ( {θ}_{1} ) - {y}_{S} cos ( {θ}_{1} ) & cos ( {θ}_{1} ) & sin ( {θ}_{1} ) \\ ⋮ & ⋮ & ⋮ \\ {x}_{S} sin ( {θ}_{N} ) - {y}_{S} cos ( {θ}_{N} ) & cos ( {θ}_{N} ) & sin ( {θ}_{N} ) \\ {x}_{1}^{′} & 0 & 1 \\ ⋮ & ⋮ & ⋮ \\ {x}_{M}^{′} & 0 & 1\end{matrix} ] [ \begin{matrix}ω \\ {v}_{x 0} \\ {v}_{y 0}\end{matrix} ] .$$

Here, v_{D1} . . . v_{DN} are detected Doppler velocity components for each radar detection, θ₁ . . . θ_{N} are detected azimuth detection angles for each radar detection, v_{y1}′ . . . v_{yM}′ are determined velocity y-components for each camera detection, xₛ is an x-coordinate for the radar system, yₛ is a y-coordinate for the radar system, x_{c} is the x-position for said camera device 4 and x₁′ . . . x_{M}′ is an x-coordinate for each camera detection. For an origin of the x-axis and the y-axis, vₓ₀ is a velocity x-component and v_{y0} is a velocity y-component for an origin velocity, and ω is an angular velocity for said origin velocity, where the two-dimensional motion state comprises the origin velocity vector and the corresponding angular velocity.

According to an example, the camera device is a stereo camera. In that case, according to another example, said processing unit is arranged to integrate all stereo camera detections independently of the radar detections, enabling the radar detections to differ from the stereo camera detections. The stereo camera device is arranged to provide x-coordinates and velocity y-components for each stereo camera detection, enabling all stereo camera detection detections to be integrated in the linear equation system.

Said object is also achieved by means of a method for determining a two-dimensional motion state comprising an origin velocity vector at a known position and a corresponding angular velocity for at least one radar detection for objects outside a vehicle. The method comprises:
Obtaining at least one radar detection azimuth detection angle with respect to an x-axis.
Obtaining a corresponding radar detection Doppler velocity component that is constituted by detected Doppler velocity with respect to the radar system.

For each of said at least one radar detection, the method further comprises:
Obtaining at least one camera detection from a stereo camera device, where a sum of the number of radar detections and the number of camera detections is at least three.
Determining x-coordinates and velocity y-components for each stereo camera detection.
Determining a two-dimensional motion state of each object (11) by solving the linear equation system

$$[ \begin{matrix}{v}_{D 1} \\ ⋮ \\ {v}_{DN} \\ {v}_{y 1}^{′} \\ ⋮ \\ {v}_{yM}^{′}\end{matrix} ] = [ \begin{matrix}{x}_{S} sin ( {θ}_{1} ) - {y}_{S} cos ( {θ}_{1} ) & cos ( {θ}_{1} ) & sin ( {θ}_{1} ) \\ ⋮ & ⋮ & ⋮ \\ {x}_{S} sin ( {θ}_{N} ) - {y}_{S} cos ( {θ}_{N} ) & cos ( {θ}_{N} ) & sin ( {θ}_{N} ) \\ {x}_{1}^{′} & 0 & 1 \\ ⋮ & ⋮ & ⋮ \\ {x}_{M}^{′} & 0 & 1\end{matrix} ] [ \begin{matrix}ω \\ {v}_{x 0} \\ {v}_{y 0}\end{matrix} ] ,$$

where v_{D1} . . . v_{DN} are detected Doppler velocity components for each radar detection, θ₁ . . . θ_{N} are detected azimuth detection angles for each radar detection, v_{y1}′ v_{yM}′ are determined velocity y-components for each camera detection, xₛ is an x-coordinate for the radar system, yₛ is a y-coordinate for the radar system, x_{c} is the x-position for said stereo camera device and x₁′ . . . x_{M}′ is an x-coordinate for each camera detection. For an origin of the x-axis and the y-axis, vₓ₀ is a velocity x-component and v_{y0} is a velocity y-component for an origin velocity, and ω is an angular velocity for said origin velocity.

According to an example, the method further comprises calculating a corresponding velocity vector on an arbitrary position on or outside said object by means of said two-dimensional motion state.

According to another example, the method further comprises integrating all stereo camera detections independently of the radar detections, enabling the radar detections to differ from the stereo camera detections. The stereo camera device is used for providing x-coordinates and velocity y-components for each stereo camera detection, enabling all stereo camera detection detections to be integrated in the linear equation system.

According to another example, the method further comprises:
finding the largest group of detections with the same motion state, such that the object with the highest number of detections is identified at a first evaluation;
excluding these detections in a repetitive manner such that successively the detections of all objects are identified; and
identifying detections which do not belong to an extended object.

Other examples are disclosed in the dependent claims.

A number of advantages are obtained by means of the present disclosure. Mainly, a direct calculation of a complete two-dimensional motion state of an extended object is obtained in a single measurement cycle without any model assumptions. The solution is acquired directly in a linear equation system.

### BRIEF DESCRIPTION OF THE DRAWINGS

The present disclosure will now be described more in detail with reference to the appended drawings, where:

FIG. 1 shows a schematic top view of a vehicle with a vehicle environment detection system according to a first example;

FIG. 2 shows a first schematic top view of a vehicle environment detection system according to a second example;

FIG. 3 shows a second schematic top view of a vehicle environment detection system according to the second example;

FIG. 4 shows a flowchart for a method according to the present disclosure; and

FIG. 5 shows a flowchart for a further method according to the present disclosure.

### DETAILED DESCRIPTION

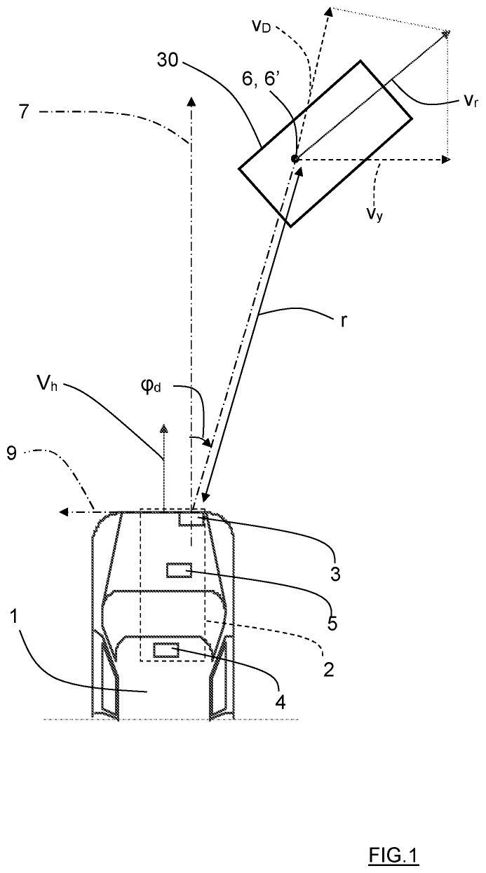

With reference to FIG. 1, showing a first example, a host vehicle 1 comprises a vehicle environment detection system 2 that in turn comprises a radar system 3 and a camera device 4 and a processing unit 5. The host vehicle 1 is moving with a certain host vehicle velocity vₕ and there is an object 30 present in the vicinity of the vehicle's path, where the object 30 is detected at a detection 6 by the radar system 3.

The detection 6 is detected by the radar system 3 as having an azimuth detection angle φ_{d} with respect to an x-axis 7 that extends from the vehicle 1 in its forward running direction, here shown extending in the same direction as the vehicle's velocity vₕ. There is also a perpendicularly extending y-axis 9, forming a camera aperture plane axis. The detection 6 further has a certain resulting velocity vᵣ that comprises a first velocity component v_{D} and a second velocity component v_{y}, where the first velocity component v_{D} is constituted by a detected Doppler velocity component and the second velocity component v_{y} is constituted by a velocity y-component that is a projection of the resulting velocity vᵣ onto y-axis 9. The radar system 3 is, however, not able to detect the second velocity component v_{y}.

According to the present disclosure, the camera device 4 is arranged to detect an optical flow that comprises at least two frames, where the processing unit 5 is arranged to determine the second velocity component v_{y} from said optical flow. The processing unit 5 is further arranged to determine said resulting velocity vᵣ from the first velocity component v_{D} and the second velocity component v_{y}.

More in detail, the radar system 3 measures the distance between the vehicle 1 and the detection 6, as well as said detection angle φ_{d} and the Doppler velocity v_{D} of the detection 6. The position of the detection 6 is converted in an image plane enabling identification of the corresponding pixel. In the image plane, the optical flow is calculated for that pixel, or a region around it. The optical flow is then transformed back in world coordinates. The motion state in the form of the resulting velocity vᵣ for the detection is then calculated.

The camera device 5 may comprise a mono camera or a stereo camera, where a stereo camera provides a scene flow with depth information. An arbitrary number of camera devices and radar systems may of course be used. There may be one radar system with a plurality of radar sensors.

Generally, a Doppler radar system is only able to determine the first velocity component v_{D}, which is mainly equal to the longitudinal movement. A single optical flow, derived from a mono camera device, or scene flow, derived from a stereo camera device, can optional be improved with the distance/depth information provided by a radar system. This optical flow is used for a precisely estimation of the lateral motion in the image domain. Combining the acquired velocity information yields to a great improvement in accuracy and the possibility to determine the movement of a single detection 6 belonging to an object 30, for example other traffic participants, vehicles, trucks, bicycles etc. in a single measurement cycle, where at least two frames are required for the optical flow.

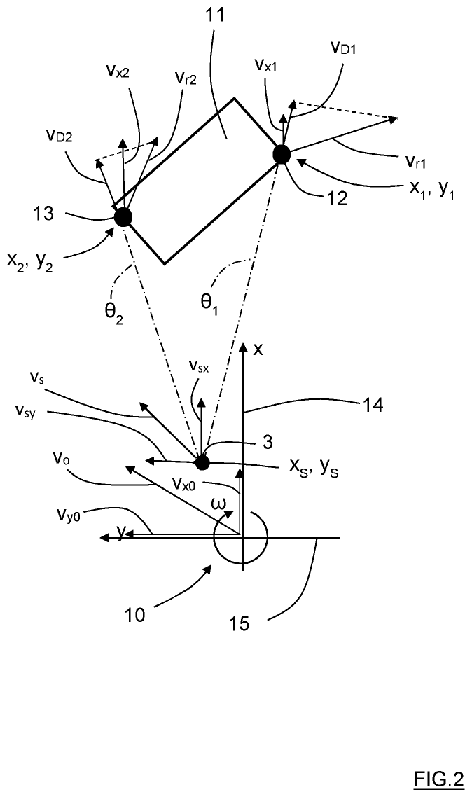

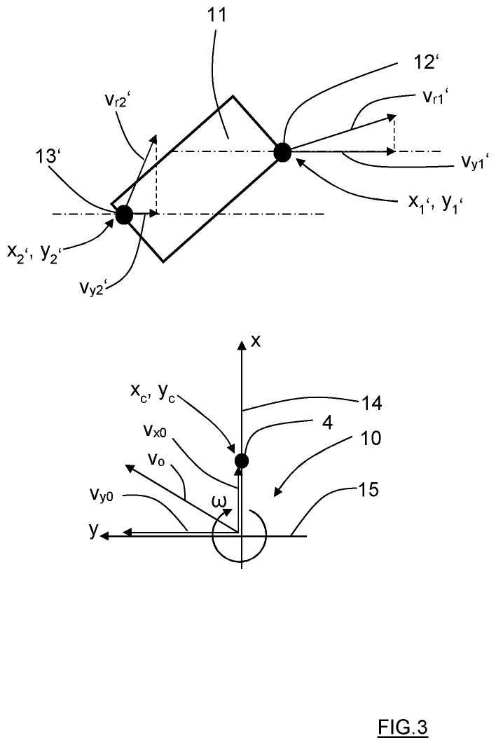

With reference to FIG. 2 and FIG. 3, showing a second example, a more schematical view is presented, where FIG. 2 shows the position xₛ, yₛ of the radar system 3 in a coordinate system 10 having an x-axis 14 and a y-axis 15, and FIG. 3 shows the position x_{c}, y_{c} of the camera device 4 in the coordinate system 10. In both FIG. 2 and FIG. 3, there is a target object 11, such as another vehicle, that is detected by the radar system 3 at two different radar detections 12, 13 and therefore constitutes an extended object. The camera device detects the target object 11 at two different camera detections 12′, 13′. In this example, the radar detections 12, 13 and the camera detections 12′, 13′ are at the same positions, but for a stereo camera device this does not have to be the case, as will be discussed later.

A first radar detection 12 has a first radar detection position x₁, y₁ with a first detected azimuth detection angle θ₁ (only schematically indicated for a line of direction in FIG. 2). The first radar detection 12 also has a first resulting velocity vᵣ₁ that comprises a first velocity x-component vₓ₁ and a first velocity y-component v_{y1}. Correspondingly, a second radar detection 13 has a second radar detection position x₂, y₂ with a second detected azimuth detection angle θ₂ (only schematically indicated for a line of direction in FIG. 2). Furthermore, the second radar detection 13 also has a second resulting velocity vᵣ₂ that comprises a second velocity x-component vₓ₂ and a second velocity y-component v_{y2}.

With reference to the origin of the coordinate system, the first resulting velocity vᵣ₁ is expressed in its components as vₓ₁, v_{y1} as:

$$[ \begin{matrix}{v}_{x 1} \\ {v}_{y 1}\end{matrix} ] = [ \begin{matrix}- {y}_{1} & 1 & 0 \\ {x}_{1} & 0 & 1\end{matrix} ] [ \begin{matrix}ω \\ {v}_{x 0} \\ {v}_{y 0}\end{matrix} ] . \qquad ( 1 )$$

where vₓ₀ is a velocity x-component and v_{y0} is a velocity y-component for an origin velocity v₀ at the origin of the coordinate system 10 and ω is an angular velocity for the origin velocity v₀. Generally, the above equation (1) holds for an arbitrary point N on or outside the target object 11 with a known position x_{N},y_{N}.

The full 2D motion state of the extended object 11 is expressed by means of the origin velocity vector v₀ at a known position and the angular velocity, yaw rate, ω. As reference point, the origin of the coordinate system 10 is used in this example. Generally, any reference point can be used since the origin velocity vector v₀ can be transformed to any position. Equation (1) describes a transformation of the origin velocity vector v₀ from the origin of the coordinate system 10 to the first radar detection position x₁, y₁, and is thus independent of the position x_{S}, y_{S} of the radar system 3.

A radar velocity vector v_{S} at the position x_{S}, y_{S} of the radar system 3 with its components v_{xS},v_{yS} is expressed as:

$$[ \begin{matrix}{v}_{xS} \\ {v}_{yS}\end{matrix} ] = [ \begin{matrix}- {y}_{S} & 1 & 0 \\ {x}_{S} & 0 & 1\end{matrix} ] [ \begin{matrix}ω \\ {v}_{x 0} \\ {v}_{y 0}\end{matrix} ] . \qquad ( 2 )$$

As shown in FIG. 2, Doppler measurements using the radar system 3 provides radial detected Doppler velocity components for the detection positions; for the first detection 12 there is a first detected Doppler velocity component v_{D1} and for the second detection 13 there is a second detected Doppler velocity component v_{D2}. The first detected Doppler velocity component v_{D1} is expressed as:

$$[ {v}_{D 1} ] = [ \begin{matrix}cos ( {θ}_{1} ) & sin ( {θ}_{1} )\end{matrix} ] [ \begin{matrix}{v}_{x S} \\ {v}_{y S}\end{matrix} ] . \qquad ( 3 )$$

Combining the equations (2) and (3) for all velocity components, assuming an arbitrary number N of radar detections, results in the more general expression below:

$$[ \begin{matrix}{v}_{D 1} \\ ⋮ \\ {v}_{DN}\end{matrix} ] = [ \begin{matrix}{x}_{S } s in ( {θ}_{1} ) - {y}_{S} cos ( {θ}_{1} ) & cos ( {θ}_{1} ) & sin ( {θ}_{1} ) \\ ⋮ & ⋮ & ⋮ \\ {x}_{S} sin ( {θ}_{N} ) - {y}_{S} cos ( {θ}_{N} ) & cos ( {θ}_{N} ) & sin ( {θ}_{N} )\end{matrix} ] [ \begin{matrix}ω \\ {v}_{x 0} \\ {v}_{y 0}\end{matrix} ] . \qquad ( 4 )$$

As shown in FIG. 3, a first camera detection 12′ has a first camera detection position x₁′, y₁′ and has a first resulting velocity vᵣ₁′ that comprises a first velocity x-component vₓ₁′ and a first velocity y-component v_{y1}′. Correspondingly, a second camera detection 13′ has a second camera detection position x₂′, y₂′ and has a second resulting velocity vᵣ₂′ that comprises a second velocity x-component vₓ₂′ and a second velocity y-component v_{y2}′. The first camera detection position x₁′, y₁′ is the sum of the measured distance by camera, optionally with support of the distance measurement by means of the radar system 3, and the camera device mounting position x_{c}, y_{c}.

The camera device 4 provides lateral velocity y-components v_{y1}′, v_{y2}′ that are projected on the y-axis by means of the optical flow. The first velocity y-component v_{y1}′ is expressed as:

$$[ {v}_{y 1}^{′} ] = [ \begin{matrix}{x}_{1}^{′} & 0 & 1\end{matrix} ] [ \begin{matrix}ω \\ {v}_{x 0} \\ {v}_{y 0}\end{matrix} ] . \qquad ( 5 )$$

Combining the equations (4) and (5) for all velocity components, assuming an arbitrary number N of radar detections and an arbitrary number M of camera detections, results in:

$$[ \begin{matrix}{v}_{D 1} \\ ⋮ \\ {v}_{DN} \\ {v}_{y 1}^{′} \\ ⋮ \\ {v}_{yM}^{′}\end{matrix} ] = [ \begin{matrix}{x}_{S} sin ( {θ}_{1} ) - {y}_{S} cos ( {θ}_{1} ) & cos ( {θ}_{1} ) & sin ( {θ}_{1} ) \\ ⋮ & ⋮ & ⋮ \\ {x}_{S} sin ( {θ}_{N} ) - {y}_{S} cos ( {θ}_{N} ) & cos ( {θ}_{N} ) & sin ( {θ}_{N} ) \\ {x}_{1}^{′} & 0 & 1 \\ ⋮ & ⋮ & ⋮ \\ {x}_{M}^{′} & 0 & 1\end{matrix} ] [ \begin{matrix}ω \\ {v}_{x 0} \\ {v}_{y 0}\end{matrix} ] . \qquad ( 6 )$$

The numbers N and M may be suitably chosen, and can be equal as well as unequal. As stated previously, having the motion state v₀, ω at the origin, the velocity vector at any position on the object 11 can be calculated using equation (1).

Here the same principle as in the first example is used, combing radar detections with optical flow from a camera device. Here, however, multiple detections belonging to the same object are used, enabling detection of angular velocity, for example yaw rate. A direct calculation of a complete two-dimensional motion state of an extended object, without any model assumptions, is obtained in a single measurement cycle. The solution is acquired directly in the linear equation system (6).

If a linear motion state, ω=0, is assumed, e.g. on a highway, the first column of the linear equation system (6), the first row of the motion state, can be deleted. By determining only two motion parameters the accuracy is increased.

As in the first example, the camera device 5 may comprise a mono camera or a stereo camera, where a stereo camera provides a scene flow with depth information. An arbitrary number of camera devices and radar systems may of course be used. There may be one radar system with a plurality of radar sensors.

If a stereo camera device is used, the scene flow/optical flow of all detections of the camera device 4 can be directly integrated, instead of calculating the radar position in the image domain as in the first example. This means that all detections of the stereo camera are integrated independently of the radar detections and thus the radar detections 12, 13 can differ from the camera detections 12′, 13′. A stereo camera device is able to directly provide x-coordinates x₁′ . . . x_{M}′ and velocity y-components v_{yM}′ for each stereo camera detection 12′, 13′, enabling all detections 12′, 14′ to be integrated in the linear equation system (6). This means that the radar detections 12, 13 can be identical to the camera detections 12′, 13′ as well as be different from and independent of the detections 12′, 13′. The camera x-coordinate x_{c} is mandatory.

It is thus possible to integrate all stereo camera detections 12′, 13′ independently of the radar detections 12, 13, enabling the radar detections 12, 13 to differ from the stereo camera detections 12′, 13′. The stereo camera device 4 is arranged to provide x-coordinates x₁′ . . . x_{M}′ and velocity y-components v_{y1}′ . . . v_{yM}′ for each stereo camera detection 12′, 13′, enabling all stereo camera detection detections 12′, 13′ to be integrated in the linear equation system.

Considering a measurement space v_{Dn}, θₙ, n=1 N, for the Doppler radar detections, the detected Doppler velocity will ideally perform a cosine over azimuth angle for all detections. Sometimes clutter, micro Doppler or other vehicles cause a wrong Doppler measurement. By finding all detections which form a cosine by means of a robust approach such as e.g. RANSAC (Random sample consensus), all detections from a single extended object are grouped. RANSAC is a commonly known an iterative method to estimate parameters of a mathematical model from a set of observed data which contains outliers.

Correspondingly, considering another measurement space; v_{yn}, x_{c}, n=1 . . . N, for the camera device measurements of optical flow, the velocity y-components v_{y}n, the optical flow, performs a straight line over the x-position x_{c} for the camera device 4 for all detections. Detections from the object 11 can be identified and erroneous velocities excluded, analogous to the radar case. Using the combined equation system (6), a combined fit for radar system 3 and camera device 4 is performed, so that radar information helps to identify camera detections and vice versa.

In this approach, a kinematic distance, a “velocity difference”, is used to identify detections 12, 13 belonging to the same object 11. Therefore the equation system is built up and according to some aspects a Random sample consensus (RANSAC) algorithm is used to find detections from the extended object 11, due to the same motion state. RANSAC is arranged to find the largest group of detections with the same motion state, such that the object with the highest number of detections is identified at the first evaluation. These detections are excluded, and a RANSAC is performed again. Successively the detections of all objects are identified, and in the end detections which do not belong to an extended object, are identified.

In addition this approach can be used even after a segmentation step, so that all falsely segmented detections or detections with an erroneous motion state (e.g. Micro-Doppler from Radar, wrong associations from optical flow) are excluded.

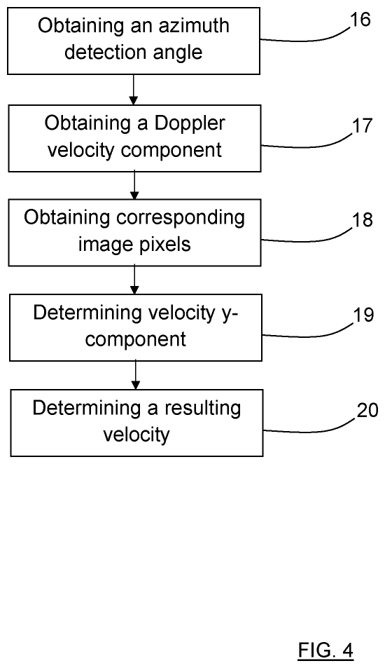

With reference to FIG. 4, the present disclosure relates to a method for determining a resulting velocity vᵣ; vᵣ₁, vᵣ₂ for at least one detection 6; 12, 13 for objects 11 outside a vehicle 1. The method comprises:

16: Obtaining at least one azimuth detection angle φ_{d}, θ₁, θ₂ with respect to an x-axis 7, 14.

17: Obtaining a corresponding detected Doppler velocity component v_{D}; v_{D1}, v_{D2} that is constituted by detected Doppler velocity with respect to the radar system 3.

18: Obtaining corresponding image pixels from a camera device 4 for at least two image frames, constituting an optical flow.

19: Determining a velocity y-component v_{y}; v_{y1}, v_{y2} from said optical flow, where the velocity y-component v_{y}; v_{y1}, v_{y2} is constituted by a projection of the resulting velocity vᵣ; vᵣ₁, vᵣ₂ onto a y-axis 9, 15 that extends perpendicular to the x-axis 7, 14 and forms an aperture plane axis for said camera device 4. 20: Determining the resulting velocity vᵣ; vᵣ₁, vᵣ₂ from the detected Doppler velocity component v_{D}; v_{D1}, v_{D2} and the velocity y-component v_{y}; v_{y1}, v_{y2}.

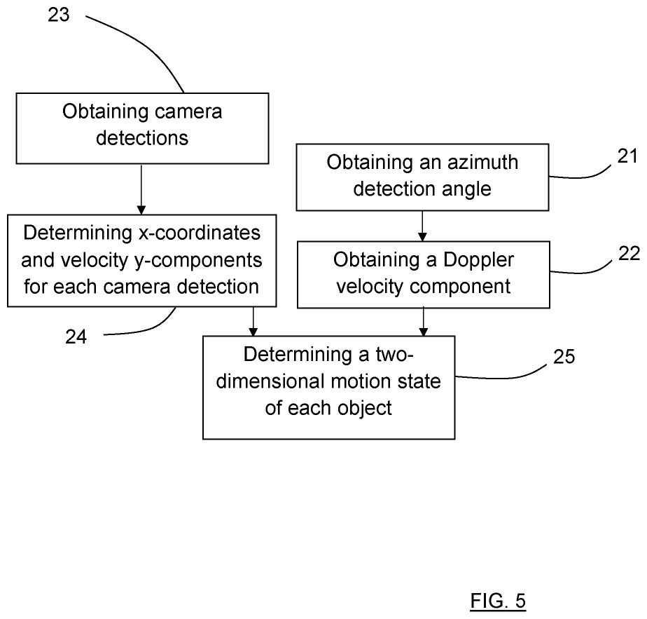

With reference to FIG. 5, when a stereo camera is used, the present disclosure relates to a method for determining a two-dimensional motion state comprising an origin velocity vector v₀ at a known position and a corresponding angular velocity ω for at least one radar detection 12, 13 for objects 11 outside a vehicle. The method comprises:

21: Obtaining at least one radar detection azimuth detection angle θ₁, θ₂ with respect to an x-axis 14.

22: Obtaining a corresponding radar detection Doppler velocity component v_{D1}, v_{D2} that is constituted by detected Doppler velocity with respect to the radar system 3.

For each of said at least one radar detection 12, 13, the method further comprises:

23: Obtaining at least one camera detection 12′, 13′ from a stereo camera device 4, where a sum of the number of radar detections 12, 13 and the number of camera detections 12′, 13′ is at least three.

24: Determining x-coordinates x₁′ . . . x_{M}′ and velocity y-components v_{y1}′ . . . v_{yM}′ for each stereo camera detection 12′, 13′.

25: Determining a two-dimensional motion state of each object 11 by solving the linear equation system

$$[ \begin{matrix}{v}_{D 1} \\ ⋮ \\ {v}_{DN} \\ {v}_{y 1}^{′} \\ ⋮ \\ {v}_{yM}^{′}\end{matrix} ] = [ \begin{matrix}{x}_{S} sin ( {θ}_{1} ) - {y}_{S} cos ( {θ}_{1} ) & cos ( {θ}_{1} ) & sin ( {θ}_{1} ) \\ ⋮ & ⋮ & ⋮ \\ {x}_{S} sin ( {θ}_{N} ) - {y}_{S} cos ( {θ}_{N} ) & cos ( {θ}_{N} ) & sin ( {θ}_{N} ) \\ {x}_{1}^{′} & 0 & 1 \\ ⋮ & ⋮ & ⋮ \\ {x}_{M}^{′} & 0 & 1\end{matrix} ] [ \begin{matrix}ω \\ {v}_{x 0} \\ {v}_{y 0}\end{matrix} ] ,$$

where v_{D1} . . . v_{DN} are detected Doppler velocity components for each radar detection 12, 13, θ₁ . . . θ_{N} are detected azimuth detection angles for each radar detection 12, 13, v_{y1}′ . . . v_{y}M′ are determined velocity y-components for each camera detection 12′, 13′, xₛ is an x-coordinate for the radar system 3, yₛ is a y-coordinate for the radar system 3, x_{c} is the x-position for said stereo camera device 4 and x₁′ . . . x_{M}′ is an x-coordinate for each camera detection 12′, 13′. For an origin of the x-axis 14 and the y-axis 15, vₓ₀ is a velocity x-component and v_{y0} is a velocity y-component for an origin velocity v₀, and ω is an angular velocity for said origin velocity v₀.

The present disclosure is not limited to the examples above, but may vary freely within the scope of the appended claims. For example, the microwave parts of the radar system 2 are assumed to be of a previously known design, and the radar system 2 comprises more parts than shown, for example a radar transmitter, a radar receiver and a receiving antenna array. The radar system 2 may furthermore comprise a number of other parts, and is for example connected to a warning and/or information device comprised in the vehicle 1 in a previously known manner.

The calculations and determining procedures are performed by the processing unit 4, where the processing unit 4 should be regarded as a processing unit arrangement that is in the form of one unit or several units that either co-operate or handle different tasks more or less independently. In the case of several units, these may be placed adjacent to each other, or in a distributed manner. A processing unit or units may be positioned at any suitable place, for example in the camera device, in the radar system or at another suitable place or places.

All details given in the example are of course only given as an illustration of the present disclosure, and should not be regarded as limiting in any way.

According to some aspects, the camera detections 12′, 13′ correspond to image pixels. The processing unit 5 is arranged to obtain at least one camera detection 12′, 13′ from said camera device 4. The sum of the number of radar detections 12, 13 and the number of camera detections 12′, 13′ is at least three.

Generally, the present disclosure relates to a vehicle environment detection system 2 arranged to detect at least one detection 6, 6′; 12, 13; 12′, 13′ for at least one corresponding object 30, 11 outside a vehicle 1, the vehicle environment detection system 2 comprising at least one radar system 3, at least one camera device 4 and at least one processing unit 5, where, for each radar detection 6; 12, 13, said radar system 3 is arranged to obtain at least one azimuth detection angle φ_{d}, θ₁, θ₂ with respect to an x-axis 7, 14 and a detected Doppler velocity component v_{D}; v_{D1}, v_{D2} that is constituted by detected Doppler velocity with respect to the radar system 3. For each detection said processing unit 5 is arranged to
obtain corresponding camera detections 6′; 12′, 13′ from said camera device 4 for at least two image frames, constituting an optical flow,
determine a velocity y-component v_{y}; v_{y1}′, v_{y2}′ from said optical flow, where the velocity y-component v_{y}; v_{y1}′, v_{y2}′ is constituted by a projection of a resulting velocity vᵣ; vᵣ₁, vᵣ₂; vᵣ₁′, vᵣ₂′ onto a y-axis 9, 15 that extends perpendicular to the x-axis 7, 14 and forms an aperture plane axis for said camera device 4, and to
determine the resulting velocity vᵣ; vᵣ₁, vᵣ₂; vᵣ₁′, vᵣ₂′ from the detected Doppler velocity component v_{D}; v_{D1}, v_{D2} and the velocity y-component v_{y}; v_{y1}, v_{y2}; vᵣ₁′, vᵣ₂′.

According to an example, for each one of said at least one radar system 3, and for each one of said at least one camera device 4, the vehicle environment detection system 2 is arranged to detect a target object 11 at at least one radar detection 12, 13, each radar detection 12, 13 having a corresponding radar detection position x₁, y₁; x₂, y₂, where said processing unit 5 is arranged to obtain at least one camera detection 12′, 13′ from said camera device 4, and where a sum of the number of radar detections 12, 13 and the number of camera detections 12′, 13′ is at least three, where furthermore the vehicle environment detection system 2 is arranged to calculate a two-dimensional motion state of the target object 11 by solving the linear equation system

$$[ \begin{matrix}{v}_{D 1} \\ ⋮ \\ {v}_{DN} \\ {v}_{y 1}^{′} \\ ⋮ \\ {v}_{yM}^{′}\end{matrix} ] = [ \begin{matrix}{x}_{S} sin ( {θ}_{1} ) - {y}_{S} cos ( {θ}_{1} ) & cos ( {θ}_{1} ) & sin ( {θ}_{1} ) \\ ⋮ & ⋮ & ⋮ \\ {x}_{S} sin ( {θ}_{N} ) - {y}_{S} cos ( {θ}_{N} ) & cos ( {θ}_{N} ) & sin ( {θ}_{N} ) \\ {x}_{1}^{′} & 0 & 1 \\ ⋮ & ⋮ & ⋮ \\ {x}_{M}^{′} & 0 & 1\end{matrix} ] [ \begin{matrix}ω \\ {v}_{x 0} \\ {v}_{y 0}\end{matrix} ] ,$$

where v_{D1} . . . v_{DN} are detected Doppler velocity components for each radar detection 12, 13, θ₁ . . . θ_{N} are detected azimuth detection angles for each radar detection 12, 13, v_{y}i′ v_{y}M′ are determined velocity y-components for each camera detection 12′, 13′, xₛ is an x-coordinate for the radar system 3, yₛ is a y-coordinate for the radar system 3, x_{c} is the x-position for said camera device 4 and x₁′ . . . x_{M}′ is an x-coordinate for each camera detection 12′, 13′, where furthermore, for an origin of the x-axis 14 and the y-axis 15, vₓ₀ is a velocity x-component and v_{y0} is a velocity y-component for an origin velocity v₀, and ω is an angular velocity for said origin velocity v₀, where the two-dimensional motion state comprises the origin velocity vector v₀, and the corresponding angular velocity ω.

According to an example, the vehicle environment detection system 2 is arranged to find the largest group of detections with the same motion state, such that the object with the highest number of detections is identified at a first evaluation, and to exclude these detections in a repetitive manner such that successively the detections of all objects are identified, and detections which do not belong to an extended object, are identified.

According to an example, the camera device is a stereo camera.

Generally, the present disclosure also relates to a method for determining a resulting velocity vᵣ; vᵣ₁, vᵣ₂ for at least one detection 6, 6′; 12, 13; 12′, 13′ for objects 11 outside a vehicle 1, where the method comprises:

16: obtaining at least one radar detection azimuth detection angle φ_{d}, θ₁, θ₂ with respect to an x-axis 7, 14 using a radar system 3; and

17: obtaining a corresponding detected Doppler velocity component v_{D}; v_{D1}, v_{D2} that is constituted by detected Doppler velocity with respect to the radar system 3.

For each detection the method further comprises:

18: obtaining corresponding camera detections 6′; 12′, 13′ from a camera device 4 for at least two image frames, constituting an optical flow;

19: determining a velocity y-component v_{y}; v_{y1}, v_{y2} from said optical flow, where the velocity y-component v_{y}; v_{y1}, v_{y2} is constituted by a projection of the resulting velocity vᵣ; vᵣ₁, vᵣ₂ onto a y-axis 9, 15 that extends perpendicular to the x-axis 7, 14 and forms an aperture plane axis for said camera device 4; and

20: determining the resulting velocity vᵣ; vᵣ₁, vᵣ₂ from the detected Doppler velocity component v_{D}; v_{D1}, v_{D2} and the velocity y-component v_{y}; v_{y1}, v_{y2}.

Generally, the present disclosure also relates to a vehicle environment detection system 2 arranged to detect at least one radar detection 12, 13 for objects 11 outside a vehicle 1, the vehicle environment detection system 2 comprising at least one radar system 3, at least one camera device 4 and at least one processing unit 5, where, for each radar detection 12, 13, said radar system 3 is arranged to obtain at least one azimuth detection angle φ_{d}, θ₁, θ₂ with respect to an x-axis 7, 14 and a detected Doppler velocity component v_{D1}, v_{D2} that is constituted by detected Doppler velocity with respect to the radar system 3. Said processing unit 5 is arranged to obtain at least one camera detection 12′, 13′ from said camera device 4, and where a sum of the number of radar detections 12, 13 and the number of camera detections 12′, 13′ is at least three, where furthermore the vehicle environment detection system 2 is arranged to calculate a two-dimensional motion state of the target object 11 by solving the linear equation system

$$[ \begin{matrix}{v}_{D 1} \\ ⋮ \\ {v}_{DN} \\ {v}_{y 1}^{′} \\ ⋮ \\ {v}_{yM}^{′}\end{matrix} ] = [ \begin{matrix}{x}_{S} sin ( {θ}_{1} ) - {y}_{S} cos ( {θ}_{1} ) & cos ( {θ}_{1} ) & sin ( {θ}_{1} ) \\ ⋮ & ⋮ & ⋮ \\ {x}_{S} sin ( {θ}_{N} ) - {y}_{S} cos ( {θ}_{N} ) & cos ( {θ}_{N} ) & sin ( {θ}_{N} ) \\ {x}_{1}^{′} & 0 & 1 \\ ⋮ & ⋮ & ⋮ \\ {x}_{M}^{′} & 0 & 1\end{matrix} ] [ \begin{matrix}ω \\ {v}_{x 0} \\ {v}_{y 0}\end{matrix} ] ,$$

where v_{D1} . . . v_{DN} are detected Doppler velocity components for each radar detection 12, 13, θ₁ . . . θ_{N} are detected azimuth detection angles for each radar detection 12, 13, v_{y1}′ . . . v_{yM}′ are determined velocity y-components for each camera detection 12′, 13′, xₛ is an x-coordinate for the radar system 3, yₛ is a y-coordinate for the radar system 3, x_{c} is the x-position for said camera device 4 and x₁′ . . . x_{M}′ is an x-coordinate for each camera detection 12′, 13′, where furthermore, for an origin of the x-axis 14 and the y-axis 15, vₓ₀ is a velocity x-component and v_{y0} is a velocity y-component for an origin velocity v₀, and ω is an angular velocity for said origin velocity v₀, where the two-dimensional motion state comprises the origin velocity vector v₀ and the corresponding angular velocity ω.

According to an example, the vehicle environment detection system 2 is arranged to calculate corresponding velocity vector on an arbitrary position on or outside said object 11 by means of said two-dimensional motion state.

According to an example, the vehicle environment detection system 2 is arranged to integrate either said velocity vector or said two-dimensional motion state by means of temporal filtering.

According to an example, the vehicle environment detection system 2 is arranged to find the largest group of detections with the same motion state, such that the object with the highest number of detections is identified at a first evaluation, and to exclude these detections in a repetitive manner such that successively the detections of all objects are identified, and detections which do not belong to an extended object, are identified.

According to an example, the camera device is a stereo camera.

According to an example, said processing unit 5 is arranged to integrate all stereo camera detections 12′, 13′ independently of the radar detections 12, 13, enabling the radar detections 12, 13 to differ from the stereo camera detections 12′, 13′, where the stereo camera device 4 is arranged to provide x-coordinates x₁′ . . . x_{M}′ and velocity y-components v_{y1}′ . . . v_{yM}′ for each stereo camera detection 12′, 13′, enabling all stereo camera detection detections 12′, 13′ to be integrated in the linear equation system.

Generally, the present disclosure also relates to a method for determining a two-dimensional motion state comprising an origin velocity vector v₀ at a known position and a corresponding angular velocity ω for at least one radar detection 12, 13 for objects 11 outside a vehicle 1, where the method comprises:

21: obtaining at least one radar detection azimuth detection angle θ₁, θ₂ with respect to an x-axis 14; and

22: obtaining a corresponding radar detection Doppler velocity component v_{D1}, v_{D2} that is constituted by detected Doppler velocity with respect to the radar system 3.

For each of said at least one radar detection 12, 13 the method further comprises:

23: obtaining at least one camera detection 12′, 13′ from a stereo camera device 4, where a sum of the number of radar detections 12, 13 and the number of camera detections 12′, 13′ is at least three;

24: determining x-coordinates x₁′ . . . x_{M}′ and velocity y-components v_{y1}′ . . . v_{yM}′ for each stereo camera detection 12′, 13′; and

25: determining a two-dimensional motion state of each object 11 by solving the linear equation system

$$[ \begin{matrix}{v}_{D 1} \\ ⋮ \\ {v}_{DN} \\ {v}_{y 1}^{′} \\ ⋮ \\ {v}_{yM}^{′}\end{matrix} ] = [ \begin{matrix}{x}_{S} sin ( {θ}_{1} ) - {y}_{S} cos ( {θ}_{1} ) & cos ( {θ}_{1} ) & sin ( {θ}_{1} ) \\ ⋮ & ⋮ & ⋮ \\ {x}_{S} sin ( {θ}_{N} ) - {y}_{S} cos ( {θ}_{N} ) & cos ( {θ}_{N} ) & sin ( {θ}_{N} ) \\ {x}_{1}^{′} & 0 & 1 \\ ⋮ & ⋮ & ⋮ \\ {x}_{M}^{′} & 0 & 1\end{matrix} ] [ \begin{matrix}ω \\ {v}_{x 0} \\ {v}_{y 0}\end{matrix} ] ,$$

where v_{D1} . . . v_{DN} are detected Doppler velocity components for each radar detection 12, 13, θ₁ . . . θ_{N} are detected azimuth detection angles for each radar detection 12, 13, v_{y1}′ . . . v_{y}M′ are determined velocity y-components for each camera detection 12′, 13′, xₛ is an x-coordinate for the radar system 3, yₛ is a y-coordinate for the radar system 3, x_{c} is the x-position for said stereo camera device 4 and x₁′ . . . x_{M}′ is an x-coordinate for each camera detection 12′, 13′, where furthermore, for an origin of the x-axis 14 and the y-axis 15, vₓ₀ is a velocity x-component and v_{y0} is a velocity y-component for an origin velocity v₀, and ω is an angular velocity for said origin velocity v₀.

According to an example, the method further comprises calculating a corresponding velocity vector on an arbitrary position on or outside said object 11 by means of said two-dimensional motion state.

According to an example, the method further comprises integrating all stereo camera detections 12′, 13′ independently of the radar detections 12, 13, enabling the radar detections 12, 13 to differ from the stereo camera detections 12′, 13′, where the stereo camera device 4 is used for providing x-coordinates x₁′ . . . x_{M}′ and velocity y-components v_{y1}′ . . . v_{yM}′ for each stereo camera detection 12′, 13′, enabling all stereo camera detection detections 12′, 13′ to be integrated in the linear equation system.

According to an example, the method further comprises:
finding the largest group of detections with the same motion state, such that the object with the highest number of detections is identified at a first evaluation;
excluding these detections in a repetitive manner such that successively the detections of all objects are identified; and
   identifying detections which do not belong to an extended object.

1. A vehicle environment detection system arranged to detect at least one detection for at least one corresponding object outside a vehicle, the vehicle environment detection system comprising at least one radar system, at least one camera device (4) and at least one processing unit, where, for each radar detection, said radar system is arranged to obtain at least one azimuth detection angle with respect to an x-axis and a detected Doppler velocity component that is constituted by detected Doppler velocity with respect to the radar system, wherein for each detection said processing unit is arranged to:
obtain corresponding camera detections from said camera device for at least two image frames, constituting an optical flow,
determine a velocity y-component from said optical flow, where the velocity y-component is constituted by a projection of a resulting velocity onto a y-axis that extends perpendicular to the x-axis and forms an aperture plane axis for said camera device, and to
determine the resulting velocity from the detected Doppler velocity component and the velocity y-component.

2. The vehicle environment detection system according to claim 1, wherein for each one of said at least one radar system, and for each one of said at least one camera device, the vehicle environment detection system is arranged to detect a target object at at least one radar detection, each radar detection having a corresponding radar detection position, where said processing unit is arranged to obtain at least one camera detection from said camera device, and where a sum of the number of radar detections and the number of camera detections is at least three, where furthermore the vehicle environment detection system is arranged to calculate a two-dimensional motion state of the target object by solving the linear equation system
$$[ \begin{matrix}{v}_{D 1} \\ ⋮ \\ {v}_{DN} \\ {v}_{y 1}^{′} \\ ⋮ \\ {v}_{yM}^{′}\end{matrix} ] = [ \begin{matrix}{x}_{S} sin ( {θ}_{1} ) - {y}_{S} cos ( {θ}_{1} ) & cos ( {θ}_{1} ) & sin ( {θ}_{1} ) \\ ⋮ & ⋮ & ⋮ \\ {x}_{S} sin ( {θ}_{N} ) - {y}_{S} cos ( {θ}_{N} ) & cos ( {θ}_{N} ) & sin ( {θ}_{N} ) \\ {x}_{1}^{′} & 0 & 1 \\ ⋮ & ⋮ & ⋮ \\ {x}_{M}^{′} & 0 & 1\end{matrix} ] [ \begin{matrix}ω \\ {v}_{x 0} \\ {v}_{y 0}\end{matrix} ] ,$$
where v_{D1} . . . v_{DN} are detected Doppler velocity components for each radar detection, θ₁ . . . θ_{N} are detected azimuth detection angles for each radar detection v_{y1}′ . . . v_{yM}′ are determined velocity y-components for each camera detection xₛ is an x-coordinate for the radar system, yₛ is a y-coordinate for the radar system, x_{c} is the x-position for said camera device and x₁′ . . . x_{M}′ is an x-coordinate for each camera detection, where furthermore, for an origin of the x-axis and the y-axis, vₓ₀ is a velocity x-component and v_{y0} is a velocity y-component for an origin velocity and ω is an angular velocity for said origin velocity, where the two-dimensional motion state comprises the origin velocity vector and the corresponding angular velocity.

3. The vehicle environment detection system according to claim 2, wherein the vehicle environment detection system is arranged to find the largest group of detections with the same motion state, such that the object with the highest number of detections is identified at a first evaluation, and to exclude these detections in a repetitive manner such that successively the detections of all objects are identified, and detections which do not belong to an extended object, are identified.

4. The vehicle environment detection system according to claim 1, wherein the camera device is a stereo camera.

5. A method for determining a resulting velocity for at least one detection for objects outside a vehicle, where the method comprises:
obtaining at least one radar detection azimuth detection angle with respect to an x-axis using a radar system; and
obtaining a corresponding detected Doppler velocity component that is constituted by detected Doppler velocity with respect to the radar system;
wherein for each detection the method further comprises:
obtaining corresponding camera detections from a camera device for at least two image frames, constituting an optical flow;
determining a velocity y-component from said optical flow, where the velocity y-component is constituted by a projection of the resulting velocity onto a y-axis that extends perpendicular to the x-axis and forms an aperture plane axis for said camera device; and
determining the resulting velocity from the detected Doppler velocity component and the velocity y-component.

6. A vehicle environment detection system arranged to detect at least one radar detection for objects outside a vehicle, the vehicle environment detection system comprising at least one radar system, at least one camera device and at least one processing unit, where, for each radar detection, said radar system is arranged to obtain at least one azimuth detection angle with respect to an x-axis and a detected Doppler velocity component that is constituted by detected Doppler velocity with respect to the radar system, wherein said processing unit is arranged to obtain at least one camera detection from said camera device, and where a sum of the number of radar detections and the number of camera detections is at least three, where furthermore the vehicle environment detection system is arranged to calculate a two-dimensional motion state of the target object by solving the linear equation system
$$[ \begin{matrix}{v}_{D 1} \\ ⋮ \\ {v}_{DN} \\ {v}_{y 1}^{′} \\ ⋮ \\ {v}_{yM}^{′}\end{matrix} ] = [ \begin{matrix}{x}_{S} sin ( {θ}_{1} ) - {y}_{S} cos ( {θ}_{1} ) & cos ( {θ}_{1} ) & sin ( {θ}_{1} ) \\ ⋮ & ⋮ & ⋮ \\ {x}_{S} sin ( {θ}_{N} ) - {y}_{S} cos ( {θ}_{N} ) & cos ( {θ}_{N} ) & sin ( {θ}_{N} ) \\ {x}_{1}^{′} & 0 & 1 \\ ⋮ & ⋮ & ⋮ \\ {x}_{M}^{′} & 0 & 1\end{matrix} ] [ \begin{matrix}ω \\ {v}_{x 0} \\ {v}_{y 0}\end{matrix} ] ,$$
where v_{D1} . . . v_{DN} are detected Doppler velocity components for each radar detection, θ₁ . . . θ_{N} are detected azimuth detection angles for each radar detection, v_{y1}′ . . . v_{yM}′ are determined velocity y-components for each camera detection, xₛ is an x-coordinate for the radar system, yₛ is a y-coordinate for the radar system, x_{c} is the x-position for said camera device and x₁′ . . . x_{M}′ is an x-coordinate for each camera detection, where furthermore, for an origin of the x-axis and the y-axis, vₓ₀ is a velocity x-component and v_{y0} is a velocity y-component for an origin velocity (v₀), and ω is an angular velocity for said origin velocity, where the two-dimensional motion state comprises the origin velocity vector and the corresponding angular velocity.

7. The vehicle environment detection system according to claim 6, wherein the vehicle environment detection system is arranged to calculate corresponding velocity vector on an arbitrary position on or outside said object by means of said two-dimensional motion state.

8. The vehicle environment detection system according to claim 6, wherein the vehicle environment detection system is arranged to integrate either said velocity vector or said two-dimensional motion state by means of temporal filtering.

9. The vehicle environment detection system according to claim 6, wherein the vehicle environment detection system is arranged to find the largest group of detections with the same motion state, such that the object with the highest number of detections is identified at a first evaluation, and to exclude these detections in a repetitive manner such that successively the detections of all objects are identified, and detections which do not belong to an extended object, are identified.

10. The vehicle environment detection system according to claim 6, wherein the camera device is a stereo camera.

11. The vehicle environment detection system according to claim 10, wherein said processing unit is arranged to integrate all stereo camera detections independently of the radar detections, enabling the radar detections to differ from the stereo camera detections, where the stereo camera device is arranged to provide x-coordinates and velocity y-components for each stereo camera detection, enabling all stereo camera detection detections to be integrated in the linear equation system.

12. A method for determining a two-dimensional motion state comprising an origin velocity vector (v₀) at a known position and a corresponding angular velocity (ω) for at least one radar detection for objects outside a vehicle, where the method comprises:
obtaining at least one radar detection azimuth detection angle with respect to an x-axis; and
obtaining a corresponding radar detection Doppler velocity component that is constituted by detected Doppler velocity with respect to the radar system;
wherein for each of said at least one radar detection the method further comprises:
obtaining at least one camera detection from a stereo camera device, where a sum of the number of radar detections and the number of camera detections is at least three;
determining x-coordinates velocity y-components for each stereo camera detection; and
determining a two-dimensional motion state of each object by solving the linear equation system
$$[ \begin{matrix}{v}_{D 1} \\ ⋮ \\ {v}_{DN} \\ {v}_{y 1}^{′} \\ ⋮ \\ {v}_{yM}^{′}\end{matrix} ] = [ \begin{matrix}{x}_{S} sin ( {θ}_{1} ) - {y}_{S} cos ( {θ}_{1} ) & cos ( {θ}_{1} ) & sin ( {θ}_{1} ) \\ ⋮ & ⋮ & ⋮ \\ {x}_{S} sin ( {θ}_{N} ) - {y}_{S} cos ( {θ}_{N} ) & cos ( {θ}_{N} ) & sin ( {θ}_{N} ) \\ {x}_{1}^{′} & 0 & 1 \\ ⋮ & ⋮ & ⋮ \\ {x}_{M}^{′} & 0 & 1\end{matrix} ] [ \begin{matrix}ω \\ {v}_{x 0} \\ {v}_{y 0}\end{matrix} ] ,$$
where v_{D1} . . . v_{DN} are detected Doppler velocity components for each radar detection, θ₁ . . . θ_{N} are detected azimuth detection angles for each radar detection, v_{y1}′ v_{yM}′ are determined velocity y-components for each camera detection, xₛ is an x-coordinate for the radar system, yₛ is a y-coordinate for the radar system, x_{c} is the x-position for said stereo camera device and x₁′ . . . x_{M}′ is an x-coordinate for each camera detection, where furthermore, for an origin of the x-axis and the y-axis, vₓ₀ is a velocity x-component and v_{y0} is a velocity y-component for an origin velocity, and ω is an angular velocity for said origin velocity.

13. The method according to claim 12, wherein the method further comprises calculating a corresponding velocity vector on an arbitrary position on or outside said object by means of said two-dimensional motion state.

14. The method according to claim 12, wherein the method further comprises integrating all stereo camera detections independently of the radar detections, enabling the radar detections to differ from the stereo camera detections, where the stereo camera device is used for providing x-coordinates and velocity y-components for each stereo camera detection, enabling all stereo camera detection detections to be integrated in the linear equation system.

15. The method according to claim 12, wherein the method further comprises:
finding the largest group of detections with the same motion state, such that the object with the highest number of detections is identified at a first evaluation;
excluding these detections in a repetitive manner such that successively the detections of all objects are identified; and
identifying detections which do not belong to an extended object.
